(19) United States
(12) Patent Application Publication
(10) Pub. No.: US 2026/0277025 A1
(43) Pub. Date: Sep. 17, 2026

(54) EYEGLASS LENS AND EYEGLASSES

(71) Applicant: NITTO DENKO CORPORATION, Osaka (JP)

(72) Inventors: Emi MIYAI, Osaka (JP); Yufeng WENG, Osaka (JP); Kozo NAKAMURA, Osaka (JP)

(73) Assignee: NITTO DENKO CORPORATION, Osaka (JP)

(21) Appl. No.: 19/168,004

(22) PCT Filed: Mar. 22, 2024
(86) PCT No.: PCT/JP2024/011301

§ 371 Date: Sep. 23, 2025

(30) Foreign Application Priority Data
Mar. 27, 2023 (JP) 2023-050364

(51) Int. Cl. G02C 7/10; G02C 11/04

(52) U.S. Cl. CPC G02C 7/10; G02C 11/04

(57) ABSTRACT

The visual appearance of an eyeglass lens that allows a wearer to visually recognize light having a predetermined peak wavelength is improved. The eyeglass lens includes: a lens portion; and a light extraction portion disposed on a wearer side of the lens portion or a side opposite to the wearer side. The light extraction portion is configured to extract light having a predetermined wavelength to the wearer side, the light having been guided through an inside of the lens portion.

### TECHNICAL FIELD

The present invention relates to an eyeglass lens and eyeglasses.

### BACKGROUND ART

For example, Patent Document 1 discloses an eyeglass lens that includes an optical filter and allows a wearer to visually recognize light having a predetermined peak wavelength.

### CITATION LIST

### Patent Literature

Patent Document 1: Japanese U.S. Pat. No. 5,807,237

### SUMMARY OF THE INVENTION

### Problem to be Solved by the Invention

However, the eyeglass lens disclosed in Patent Document 1 appears tinted to a person other than the wearer of eyeglasses including the eyeglass lens. Thus, the visual appearance of the eyeglass lens may be affected.

An object of the present invention is to improve visual appearance of an eyeglass lens that allows a wearer to visually recognize light having a predetermined peak wavelength.

### Means for Solving the Problem

An eyeglass lens according to one aspect of the present invention includes: a lens portion; and a light extraction portion disposed on a wearer side of the lens portion or a side opposite to the wearer side, in which the light extraction portion is configured to extract light having a predetermined peak wavelength to the wearer side, the light having been guided through an inside of the lens portion.

### Advantageous Effects of the Invention

According to the present invention, it is possible to improve the visual appearance of the eyeglass lens that allows the wearer to visually recognize light having a predetermined peak wavelength.

### BRIEF DESCRIPTION OF THE DRAWINGS

FIG. 1 is a schematic perspective view of eyeglasses according to a first embodiment.

FIG. 2 is a cross-sectional view taken along a line II-II in FIG. 1.

FIG. 3 is a schematic front view of a light extraction portion in the eyeglasses according to the first embodiment.

FIG. 4 is a schematic cross-sectional view taken along a line IV-IV in FIG. 3.

FIG. 5 is a schematic enlarged view of a region V in FIG. 3.

FIG. 6 is a schematic enlarged view of a region VI in FIG. 4.

FIG. 7 is a schematic side view of the eyeglasses according to the first embodiment.

FIG. 8 is a schematic cross-sectional view of eyeglasses according to a first modification.

FIG. 9 is a schematic cross-sectional view of eyeglasses according to a second modification.

FIG. 10 is a schematic perspective view of eyeglasses according to a second embodiment.

### DESCRIPTION OF THE EMBODIMENTS

Hereinafter, embodiments of the present invention will be described in detail with reference to the drawings. The same components are denoted by the same reference signs throughout the drawings, and redundant descriptions are omitted as appropriate.

The embodiments described below are examples of an eyeglass lens and eyeglasses, which implement a technical idea of the present disclosure, and the present disclosure is not limited to the embodiments described below. The dimensions, materials, shapes, relative arrangements, and the like of the components described below are intended to be illustrative and not intended to limit the scope of the present disclosure thereto unless otherwise specified. The sizes, positional relationships, and the like of members illustrated in the drawings may be emphasized for clarity of explanation.

In the drawings, directions are expressed using a Cartesian coordinate system including X, Y, and Z axes. The X, Y, and Z axes are substantially orthogonal to one another. The Z direction along the Z axis indicates a normal viewing direction of a wearer wearing eyeglasses according to an embodiment. The Y direction along the Y axis indicates the vertical direction. The X direction along the X axis indicates the horizontal direction. The direction of an arrow indicating the X axis is denoted as the +X direction, and a direction opposite to the +X direction is denoted as the −X direction. The direction of an arrow indicating the Y axis is denoted as the +Y direction, and a direction opposite to the +Y direction is denoted as the −Y direction. The direction of an arrow indicating the Z axis is denoted as the +Z direction, and a direction opposite to the +Z direction is denoted as the −Z direction. As used herein, “plan view” refers to viewing a target from the normal viewing direction of a wearer, and “side view” refers to viewing the target from a direction substantially orthogonal to the normal viewing direction of the wearer. However, such directional expressions do not limit the orientation of the embodiments.

An eyeglass lens according to an embodiment includes: a lens portion; and a light extraction portion disposed on a wearer side of the lens portion or a side opposite to the wearer side. The light extraction portion is configured to extract light having a predetermined peak wavelength to the wearer side, the light having been guided through an inside of the lens portion. The light having the predetermined peak wavelength extracted to the wearer side by the light extraction unit is directed to the eye of the wearer. By irradiating the eye of the wearer with the light having the predetermined peak wavelength, the eyeglass lens according to the embodiment enables the wearer to visually recognize the light having the predetermined peak wavelength. Herein, the wearer means a person who is wearing eyeglasses including the eyeglass lens according to the embodiment.

The eyeglass lens according to the embodiment may be able to, for example, prevent a headache such as migraines of a wearer or alleviate (treat) a symptom of the headache by irradiating the eye of the wearer with light having a peak wavelength corresponding to green light. Moreover, the eyeglass lens according to the embodiment may be able to restore the vision of the wearer by irradiating the eye of the wearer with light having a peak wavelength corresponding to violet light.

Alternatively, the eyeglass lens according to the embodiment may be able to promote the ability of the wearer to sleep well and adjust the sleeping rhythm of the wearer by irradiating the eye of the wearer with light having a peak wavelength corresponding to red light. In addition to the above functions, the eyeglass lens according to the embodiment may have a function of correcting a refractive error or the vision of the eye, a function of protecting the eye like protective glasses, a function of serving as an accessory such as sunglasses or fashion glasses, or the like.

Meanwhile, in the eyeglass lens that allows the wearer to visually recognize light having a predetermined peak wavelength as described above, when the eyeglass lens appears tinted in a color corresponding to the predetermined peak wavelength to a person other than the wearer of the eyeglass lens, the visual appearance of the eyeglass lens may be affected. Moreover, when the eyeglass lens appears tinted in a color corresponding to a predetermined peak wavelength, there is a possibility that a person other than the wearer of the eyeglass lens may be able to identify that the wearer of the eyeglass lens is undergoing treatment for a headache or vision restoration using the eyeglass lens. This is not preferable in terms privacy.

In the eyeglass lens according to the embodiment, the light extraction portion extracts light having a predetermined peak wavelength mainly to the wearer side, and thus the light having the predetermined peak wavelength is not appreciably directed to the opposite side of the wearer. Therefore, a person other than the wearer cannot appreciably and visually recognize the light having the predetermined peak wavelength extracted by the light extraction portion. Accordingly, in the embodiment, it is possible to reduce deterioration in the visual appearance caused when the eyeglasses appear tinted to a person other than the wearer due to the light having the predetermined peak wavelength, thereby improving the visual appearance of the eyeglass lens that allows the wearer to visually recognize the light of the predetermined peak wavelength. Moreover, the wearer can utilize the eyeglass lens of the embodiment to prevent or treat migraines, restore vision, promote good sleep, adjust sleep rhythm, and the like without others becoming aware.

### First Embodiment

### Configuration Example of Eyeglasses 10

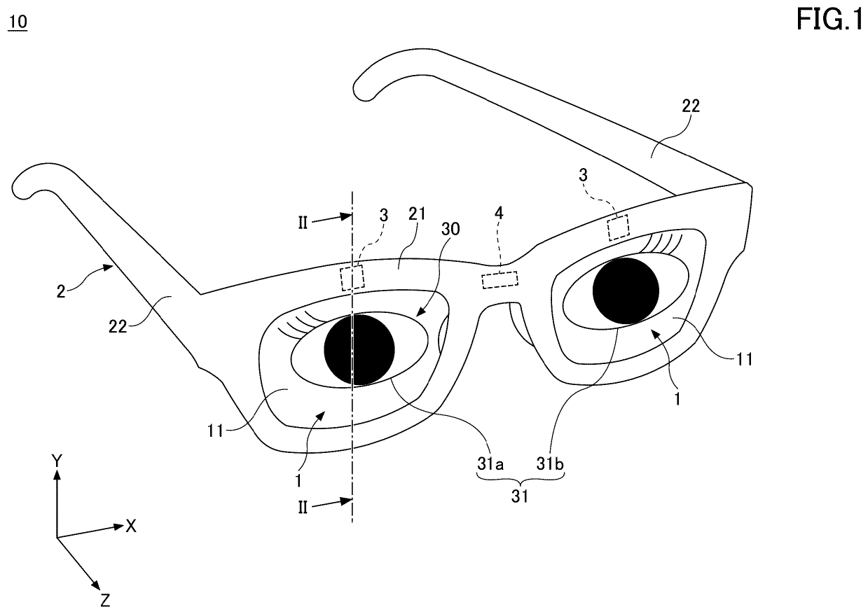

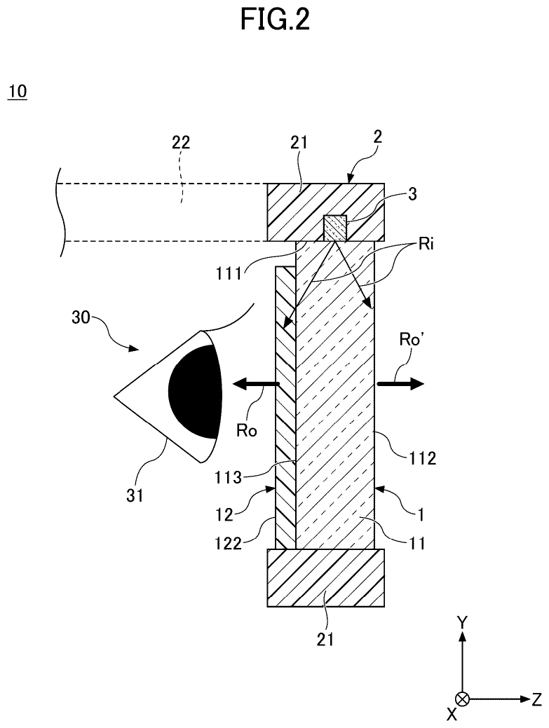

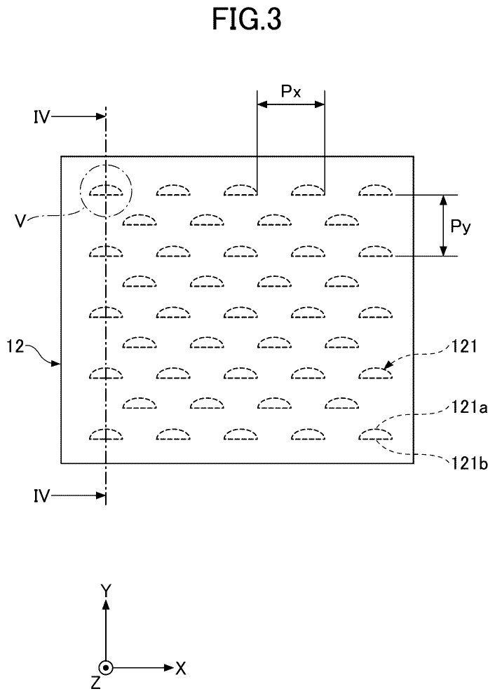

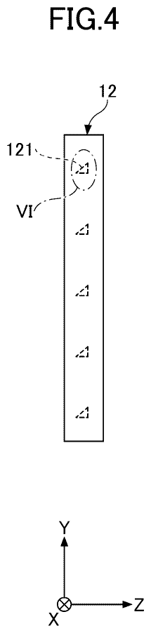

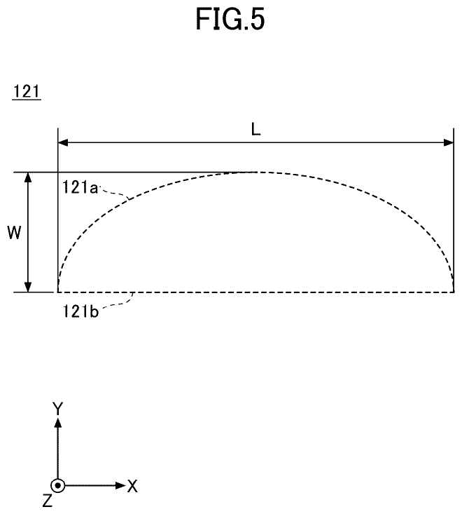

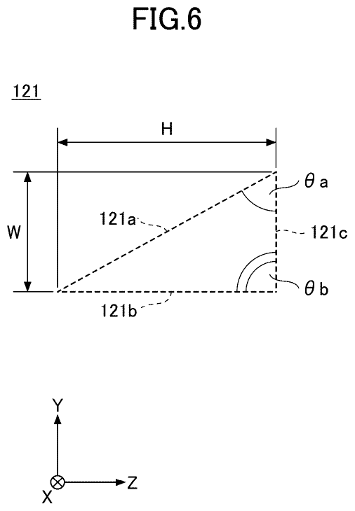

The structure and configuration of eyeglasses 10 according to a first embodiment will be described with reference to FIGS. 1 to 7. FIG. 1 is a schematic perspective view of the eyeglasses 10. FIG. 2 is a cross-sectional view taken along a line II-II in FIG. 1. FIG. 3 is a schematic front view of a light extraction portion 12 in the eyeglasses 10. FIG. 4 is a schematic cross-sectional view taken along a line IV-IV in FIG. 3. FIG. 5 is a schematic enlarged view of a region V in FIG. 3. FIG. 6 is a schematic enlarged view of a region VI in FIG. 4.

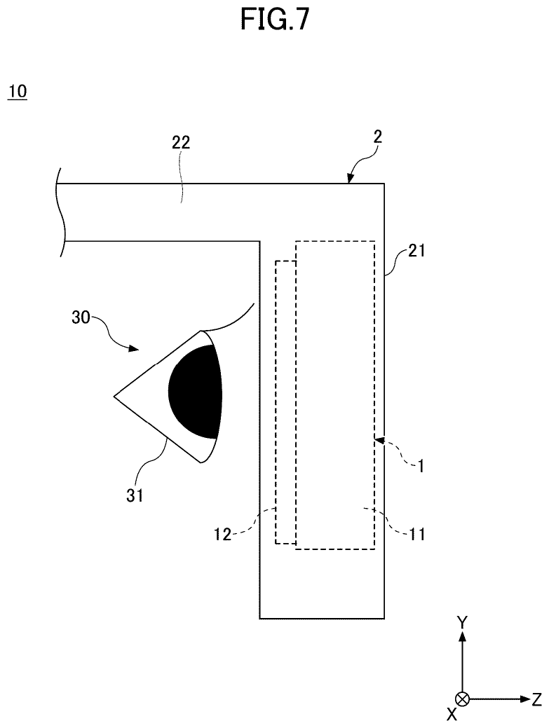

FIG. 7 is a schematic side view of the eyeglasses 10.

As illustrated in FIGS. 1 and 2, the eyeglasses 10 include eyeglass lenses 1, a support 2 for the eyeglass lenses 1, and light sources 3. The eyeglasses 10 illustrated herein include a pair of eyeglass lenses 1 for a right eye 31a and a left eye 31b of a wearer 30 of the eyeglasses 10 (hereinafter, simply referred to as the wearer 30). Note that the eyeglasses 10 may include the eyeglass lens 1 according to the embodiment for at least one of the right eye 31a or the left eye 31b of the wearer 30.

Each of the eyeglass lenses 1 includes a lens portion 11 and the light extraction portion 12. The wearer 30 can see, through the lens portions 11 and the light extraction portions 12, a space located on the +Z direction side of the eyeglass lenses 1.

The lens portion 11 is a flat and rigid member formed of a material having a high visible-light transmittance. The lens portion 11 preferably has a visible-light transmittance of 60% or higher. The eyeglass lens 1 in plan view may be shaped substantially rectangular, substantially circular, substantially elliptical, or the like, or may be optimized in accordance with the shape of the face or the shape of the eyes of the wearer 30. The lens portion 11 includes, for example, an acrylic resin (e.g., polymethyl methacrylate), a polycarbonate resin, a cycloolefin resin, a glass (e.g., soda glass, quartz glass, alkali-free glass, or borosilicate glass), or the like.

In a case where the eyeglasses 10 have a function of correcting refractive errors or vision of the eyes, the lens portion 11 may have a spherical surface or an aspherical surface at at least one surface of the flat and rigid member. The spherical shape, the aspherical shape, the refractive index, or the thickness of the lens portion 11 can be set as appropriate according to the diopter of the eyeglass lens 1. The refractive index of the lens portion 11 ranges, for example, from 1.40 to 1.80, inclusive. Unless otherwise specified, the refractive index refers to a refractive index measured with an ellipsometer at a wavelength of 550 nm. In a case where the eyeglasses 10 have a function of protecting the eyes or serving as an accessory, the lens portion 11 may be tinted.

As illustrated in FIG. 2, the light extraction portion 12 is disposed on the wearer 30 side of the lens portion 11, that is, on the −Z direction side. For example, the light extraction portion 12 is disposed by being attached to a first main surface 113 of the lens portion 11. The first main surface 113 is a surface on the wearer 30 side of the lens portion 11. In the eyeglass lens 1, the light extraction portion 12 is disposed on the wearer 30 side and thus can directly extract light to the wearer 30. As a result, interference of diffracted light or Fresnel light occurring while the waves are being guided can be avoided in a case where the light extraction portion 12 is disposed on the opposite side. Therefore, ghost light can be reduced. Note that the light extraction portion 12 may be disposed on the side opposite to the wearer 30 side of the lens portion 11, that is, on the +Z direction side. For example, the light extraction portion 12 may be disposed by being attached to either the first main surface 113 or a second main surface 112 of the lens portion 11. The second main surface 112 is a surface of the lens portion 11 on the side opposite to the wearer 30 side.

The light extraction portion 12 can extract light to the wearer 30. The light has a predetermined peak wavelength and is guided through the inside of the lens portion 11. The light extraction portion 12 can extract light having a predetermined peak wavelength, which is emitted from the light source 3 into the inside of the eyeglass lens 1 and is guided through the inside of the eyeglass lens 1. The eyeglass lens 1 can cause the wearer 30 to visually recognize the light having the predetermined peak wavelength by irradiating the eye 31 of the wearer 30 with the light having the predetermined peak wavelength extracted by the light extraction portion 12.

As illustrated in FIG. 3, the light extraction portion 12 is formed of an air cavity film. The air cavity film is a member that is shaped like a film and includes a plurality of air cavities 121 therein. Each of the air cavities 121 is a hollow portion filled with a gas such as air. As illustrated in FIG. 3, the plurality of air cavities 121 are arranged in a staggered pattern in plan view. As illustrated in FIG. 4, the plurality of air cavities 121 are arranged linearly in side view along the direction (Y direction) in which the light extraction portion 12 extends. Note that the arrangement of the plurality of air cavities 121 is not limited to that illustrated in FIGS. 3 and 4, and can be changed as appropriate.

The light extraction portion 12 can be formed of a shaped film or the like. This shaped film can be produced, for example, according to the method described in Japanese Translation of PCT International Publication No. 2013-524288. Specifically, the intended unevenly shaped film can be produced by coating the surface of a polymethyl methacrylate film with a lacquer (Fine Cure RM-64, available from Sanyo Chemical Industries, Ltd.), embossing an optical pattern on the film surface containing the lacquer, and then curing the lacquer. The total thickness of the unevenly shaped film is, for example, 130 μm.

In FIG. 3, a pitch Px is a distance between the air cavities 121 adjacent to each other in the horizontal direction (X direction) substantially orthogonal to the normal viewing direction (Z direction) of the wearer 30. A pitch Py is a distance between centers of the air cavities 121 adjacent to each other in a direction (Y direction) substantially orthogonal to both the normal viewing direction of the wearer 30 and the horizontal direction.

As illustrated in FIG. 5, each of the air cavities 121 has a substantially arcuate outer shape in plan view. The air cavity 121 is defined by a curved surface 121a and a flat surface 121b. The curved surface 121a corresponds to a curved portion of the arcuate shape in plan view. The flat surface 121b corresponds to a straight portion of the arcuate shape in plan view. In plan view, L is a length of the air cavity 121 in the direction in which the straight portion of the arcuate shape extends (e.g., the X direction in FIG. 5). W is a length of the air cavity 121 in the direction orthogonal to the direction in which the straight portion of the arcuate shape extends (e.g., the Y direction in FIG. 5).

The direction in which the straight portion of the arcuate shape extends is, for example, the horizontal direction.

The direction orthogonal to the direction in which the straight portion of the arcuate shape extends is, for example, the vertical direction.

As illustrated in FIG. 6, the air cavity 121 has a substantially triangular outer shape in side view. In this substantial triangle, a side 121c is a side other than the side corresponding to the curved surface 121a and the side corresponding to the flat surface 121b. H is a length of the air cavity 121 in the normal viewing direction of the wearer 30. The length W corresponds to the length of the air cavity 121 in the direction substantially orthogonal to the normal viewing direction of the wearer 30 in side view. An angle θa is an angle between the side corresponding to the curved surface 121a and the side 121c in side view. An angle θb is an angle between the side corresponding to the flat surface 121b and the side 121c in side view.

Referring back to FIG. 1, the eyeglasses 10 will be described again. The support 2 includes a pair of rims 21 and a pair of temples 22. The pair of rims 21 are portions surrounding the respective eyeglass lenses 1 for the right eye 31a and the left eye 31b. The rim 21 encompasses an under-rim in which a support is provided only at a lower portion of the eyeglass lens 1, a half-rim in which a support is provided only at an upper half of the eyeglass lens 1, and the like. The pair of temples 22 are a pair of rod-shaped portions that support the eyeglasses 10 on the respective auricles of the right and left ears.

The support 2 includes a resin material, a metal material, or the like. To reduce the weight of the eyeglasses 10, the support 2 preferably includes a resin material. To reduce leakage of light guided through the inside of the eyeglass lens 1 in a direction other than toward the wearer 30, the support 2 preferably includes a material having a high light-absorption rate for light having a predetermined peak wavelength. Alternatively, the support 2 may include a material having a high reflectance for light having a predetermined peak wavelength. To improve the visual appearance of the eyeglasses 10, the support 2 may be colored in various colors, or in combination of colors to form various patterns, figures, characters, and the like. The support 2 may be formed in a shape that improves the visual appearance.

The light sources 3 are disposed at the support 2 and emit light. The light emitted from the light sources 3 enters the inside of the eyeglass lenses 1 supported by the support 2. Each of the light sources 3 includes, for example, a light emitting diode (LED). The light sources 3 are embedded inside the support 2 so as not to be visible from the outside. The light sources 3 emit light having a predetermined peak wavelength in accordance with electric power supplied from a power supply 4 disposed at the support 2. A primary battery, a secondary battery, or the like can be used as the power supply 4. Each of the light sources 3 may include an LED array in which a plurality of LEDs are aligned. Each of the light sources 3 may include a laser diode (LD), an LD array in which a plurality of LDs are aligned linearly, or the like.

The light sources 3 may be disposed above or below the respective eyeglass lenses 1. In the examples illustrated in FIGS. 1 and 2, one light source 3 is disposed on the upper side of the support 2 relative to the right eye 31a, and the other light source 3 is disposed on the upper side of the support 2 relative to the left eye 31b. By disposing the light source 3 above or below the eyeglass lens 1, the light emitted from the light source 3 is less likely to be visually recognized by a person other than the wearer present near the wearer 30, compared with a case where the light source 3 is disposed beside the eyeglass lens 1. Accordingly, in the present embodiment, it is possible to reduce deterioration in the visual appearance of the eyeglass lens 1 caused when light leaking from the eyeglass lens 1 is visually recognized by a person other than the wearer, thereby improving the visual appearance of the eyeglass lens 1.

Note that the position of the light source 3 disposed at the support 2 is not limited to above or below the eyeglass lens 1 as long as light can enter the inside of the eyeglass lens 1 supported by the support 2. The number of the light sources 3 is preferably large in that a large amount of light can enter the inside of the eyeglass lens 1 to irradiate the eye of the wearer 30, and the light that has entered the inside of the eyeglass lens 1 can be guided, in plan view, to a wide area inside the eyeglass lens 1 to irradiate a wide area of the eye 31 of the wearer 30. To reduce power consumption, the cost of the eyeglasses 10, the space for disposing the light sources 3, and the like, the number of the light sources 3 is preferably small.

As illustrated in FIG. 2, the light having a predetermined peak wavelength emitted from the light source 3 passes through a light incident surface 111 of the lens portion 11 and enters the inside of the lens portion 11 as incident light Ri. The incident light Ri is guided through the inside of the lens portion 11. In the example illustrated in FIG. 2, the incident light Ri is guided through the inside of the lens portion 11 to the side opposite to the side on which the light source 3 is disposed while the incident light Ri is totally reflected by the first main surface 113 and the second main surface 112. A part of the incident light Ri guided through the inside of the lens portion 11 is totally reflected to the −Z direction side by the curved surfaces 121a (see FIGS. 5 and 6) defining the plurality of air cavities 121 in the light extraction portion 12. The light totally reflected by the curved surfaces 121a passes through a light extraction surface 122 and is extracted from the lens portion 11 as exiting light Ro. The exiting light Ro is directed to the eye 31 of the wearer 30. The direction in which the incident light Ri guided through the inside of the lens portion 11 is totally reflected by the curved surfaces 121a includes not only the Z direction, that is, the normal viewing direction of the wearer 30, but also, for example, a direction intersecting the normal viewing direction of the wearer 30. The exiting direction of the exiting light Ro from the lens portion 11 also includes not only the normal viewing direction of the wearer 30 but also a direction intersecting the normal viewing direction of the wearer 30.

A predetermined peak wavelength is included in, for example, any one of a wavelength range from 380 nm to 490 nm, a wavelength range from 500 nm to 560 nm, or a wavelength range from 600 nm to 780 nm. The wavelength range from 380 nm to 490 nm corresponds to a wavelength range of violet light. The eyeglass lens 1 can restore the vision of the wearer 30 by irradiating the eye 31 of the wearer 30 with light having a peak wavelength included in the wavelength range from 380 nm to 490 nm. The wavelength range from 500 nm to 560 nm corresponds to a wavelength range of green light. The eyeglass lens 1 can prevent a headache such as migraine of the wearer 30 and alleviate (treat) symptoms of headaches by irradiating the eye 31 of the wearer 30 with light having a peak wavelength included in the wavelength range from 500 nm to 560 nm. The wavelength range from 600 nm to 780 nm corresponds to a wavelength range of red light. The eyeglass lens 1 can promote the wearer 30 to sleep well and adjust the sleeping rhythm of the wearer 30 by irradiating the eye 31 of the wearer 30 with light having a peak wavelength included in the wavelength range from 600 nm to 780 nm.

For example, the eyeglasses 10 capable of providing the respective effects of the three wavelength ranges described above are prepared separately in advance, and the wearer 30 selects which eyeglasses 10 to wear.

Accordingly, the wearer 30 can experience an effect desired by the wearer 30 among different effects provided by the respective wavelength ranges, such as those provided by the violet light, the green light, and the red light described above.

In the eyeglass lens 1, most of the light guided through the inside of the lens portion 11 can be extracted to the wearer 30 side by the light extraction portion 12, and is not extracted to the side opposite to the wearer 30 side. This can reduce the possibility that the eyeglass lens 1 appears tinted to a person other than the wearer 30 of the eyeglass lens 1. As a result, in the present embodiment, it is possible to reduce deterioration in the visual appearance of the eyeglass lens 1 caused when the eyeglass lens 1 appears tinted to a person other than the wearer 30 of the eyeglass lens 1, thereby improving the visual appearance of the eyeglass lens 1 that allows the wearer 30 to visually recognize light having a predetermined peak wavelength.

In the present embodiment, when the light amount of the exiting light Ro extracted by the light extraction portion 12 to the wearer 30 side is defined as A, and the light amount of exiting light Ro′ extracted by the light extraction portion 12 to the side opposite to the wearer 30 side is defined as B, A is greater than B (including the case where B=0), and more preferably A/B≥1.2.

Accordingly, the eyeglass lens 1 can provide effects such as prevention and treatment by irradiating the eye 31 of the wearer 30 with light having a predetermined peak wavelength. In addition, in the present embodiment, it is also possible to reduce deterioration in the visual appearance of the eyeglass lens 1 caused when light having a predetermined peak wavelength is visually recognized by a person other than the wearer 30, thereby improving the visual appearance of the eyeglass lens 1.

In the present embodiment, as illustrated in FIG. 7, the support 2 may cover the entire side surface of the eyeglass lens 1. In FIG. 7, the support 2 covers a side surface on one side (−X direction side) of the horizontal direction in the eyeglass lens 1. In the eyeglasses 10, the side surface of the eyeglass lens 1 is covered with the support 2, and thus leakage of light having a predetermined peak wavelength guided through the inside of the eyeglass lens 1 can be reduced from the side surface of the eyeglass lens 1. Accordingly, the eyeglasses 10 can reduce deterioration in the visual appearance of the eyeglass lens 1 caused when the light is visually recognized by a person other than the wearer 30, thereby improving the visual appearance of the eyeglass lens 1. In the eyeglasses 10, the entire side surface of the eyeglass lens 1 may be covered with the support 2, rather than being limited to the side surface on the-X direction side illustrated in FIG. 7. Accordingly, the eyeglasses 10 can reduce leakage of light having a predetermined peak wavelength from the entire side surface of the eyeglass lens 1, thereby improving the visual appearance of the eyeglass lens 1.

### Modifications

Various changes and modifications are possible for the eyeglass lens and the eyeglasses according to the embodiment. Hereinafter, various modifications will be described. Note that the same names and reference signs as those of the embodiment described above denote the same or similar members or components, and detailed descriptions will be omitted as appropriate. The same applies to embodiments and modifications other than those described below.

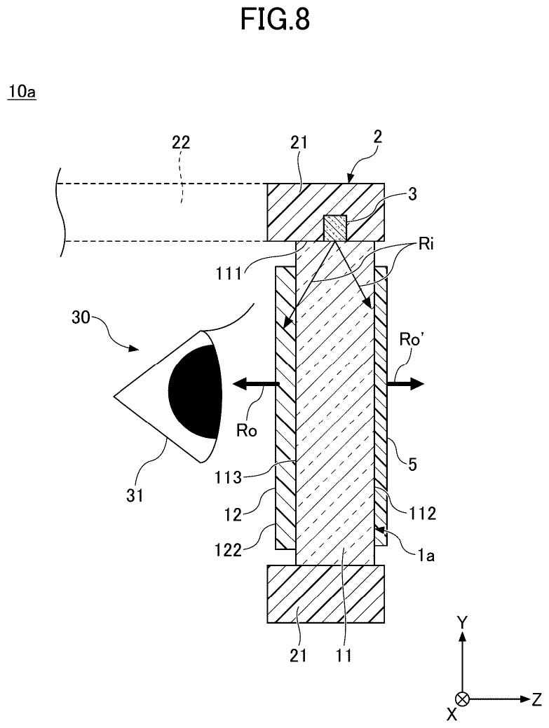

FIG. 8 is a schematic cross-sectional view of eyeglasses 10a according to a first modification. The eyeglasses 10a include an eyeglass lens la. The eyeglass lens la includes a polarizing plate 5 disposed on the side opposite to the wearer 30 side, in contrast to the eyeglass lens 1 of the first embodiment.

The polarizing plate 5 is preferably thin to reduce the size and the weight of the eyeglass lens and the eyeglasses. The polarizing plate 5 may be a polarizing film. By including the polarizing plate 5, the eyeglass lens la can reduce glare and reflection of sunlight and illumination light, thereby improving the field of view of the wearer 30. In addition, the eyeglass lens la enables the wearer 30 to see a target with high contrast even when strong light is present. Note that the polarizing plate 5 may be disposed on the wearer 30 side of the eyeglass lens la. The visible-light transmittance of the polarizing plate 5 is preferably 80% or less. For example, in a case where the wearer 30 has developed a migraine or the like, the migraine may be aggravated when bright light is incident on the eyes. When the visible-light transmittance of the polarizing plate 5 is 80% or less, it is possible to alleviate such aggravation of migraines, prevent light extracted in the eyeglasses 10a from leaking to the outside, and reduce deterioration in the visual appearance the eyeglasses 10a. The polarizing plate 5 corresponds to an example optical member that is disposed on at least one of the wearer 30 side or the side opposite to the wearer 30 side and has a visible-light transmittance of 80% or less. In the case where this optical member is disposed on both the wearer 30 side and on the side opposite to the wearer 30 side, the total visible-light transmittance of these optical members disposed on both the wearer 30 side and on the side opposite to the wearer 30 side is 80% or less.

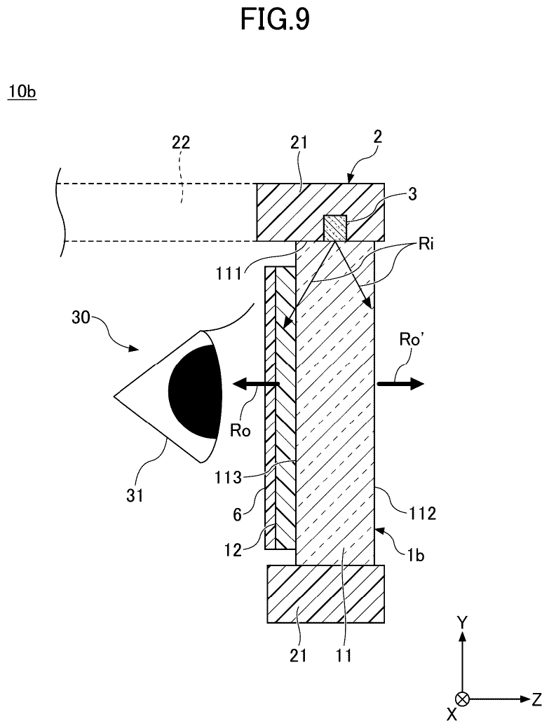

FIG. 9 is a schematic cross-sectional view of eyeglasses 10b according to a second modification. The eyeglasses 10b include an eyeglass lens 1b. The eyeglass lens 1b includes tinted film 6 disposed on the wearer 30 side, in contrast to the eyeglass lens 1 of the first embodiment.

The tinted film 6 is a film tinted in an achromatic color such as black or gray. By including the tinted film 6 in this modification, the eyeglass lens 1b can provide substantially the same operational effect as that of the polarizing plate 5. The tinted film 6 may be disposed on the side of the eyeglass lens 1b opposite to the wearer 30. In addition, in the present modification, when the visible-light transmittance of the tinted film 6 is 80% or less, substantially the same operational effect as that obtained in the case where the visible-light transmittance of the polarizing plate 5 described above is 80% or less can be obtained. The tinted film 6 corresponds to an example optical member that is disposed on at least one of the wearer 30 side or the side opposite to the wearer 30 side and has a visible-light transmittance of 80% or less.

### Second Embodiment

Next, eyeglasses according to a second embodiment will be described. In the second embodiment, a light source includes a plurality of light sources each capable of individually emitting light having a different peak wavelength, in contrast to the first embodiment.

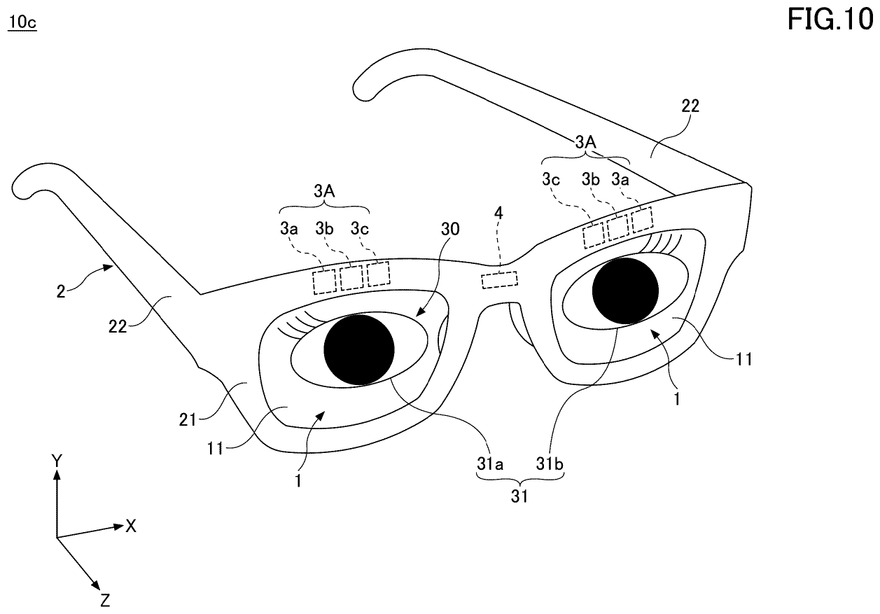

FIG. 10 is a schematic perspective view of eyeglasses 10c according to the second embodiment. The eyeglasses 10c include light sources 3A. Each of the light sources 3a includes a first light source 3a, a second light source 3b, and a third light source 3c, which are a plurality of light sources each capable of individually emitting light having a different peak wavelength. The eyeglasses 10c include one light source 3A associated with an eyeglass lens 1 for a right eye 31a and one light source 3A associated with an eyeglass lens 1 for a left eye 31b. The first light source 3a, the second light source 3b, and the third light source 3c are disposed at the support 2 so as to be horizontally (in the X direction) aligned above each of the eyeglass lenses 1 for the right eye 31a and for the left eye 31b. The first light sources 3a, the second light sources 3b, and the third light sources 3c are embedded in the support 2 so as not to be visible from the outside. Note that the light source 3A may be disposed above one of the right eye 31a or the left eye 31b.

The first light sources 3a emit light having a peak wavelength included in a wavelength range from 380 nm to 490 nm. The second light sources 3b emit light having a peak wavelength included in a wavelength range from 500 nm to 560 nm. The third light sources 3c emit light having a peak wavelength included in a wavelength range from 600 nm to 780 nm. As previously mentioned, light having a peak wavelength included in the wavelength range from 380 nm to 490 nm has an effect of restoring the vision of the wearer 30. The light having a peak wavelength included in the wavelength range from 500 nm to 560 nm has an effect of preventing a headache such as migraine of the wearer 30 or alleviating (treating) symptoms of headaches. The light having a peak wavelength in the wavelength range from 600 nm to 780 nm has an effect of promoting the ability of the wearer 30 to sleep well and adjusting the sleeping rhythm of the wearer 30. In the present embodiment, the first light sources 3a, the second light sources 3b, and the third light sources 3c can each individually emit light.

Therefore, the effect of emitting light having peak wavelengths in the three wavelength ranges can be obtained by one eyeglasses 10c.

At least two of the first light source 3a, the second light source 3b, or the third light source 3c may be each configured to individually emit light with a variable light amount. The eyeglasses 10c can obtain light in which colors of light from at least two of the first light source 3a, the second light source 3b, or the third light source 3c are mixed. That is, the light from at least two of the light sources can be mixed to obtain different colors. A light extraction portion 12 of the eyeglasses 10c can extract light with mixed colors from a plurality of light sources. The eyeglasses 10c can provide different effects to the wearer 30 according to the wavelength ranges by irradiating the eye 31 of the wearer 30 with light in the wavelength ranges obtained by color mixing. The effects other than those described above in the present embodiment are substantially the same as the effects described in the first embodiment.

In a modification of the embodiment, the eyeglass lens 1 may use, as the light extraction portion, an uneven shape formed on the surface of the eyeglass lens 1, instead of an air cavity film. The eyeglass lens 1 can extract light guided through the inside of the eyeglass lens 1 to the outside by the uneven shape serving as the light extraction portion.

The eyeglass lens 1 may have an additional functional layer. For example, the eyeglass lens 1 may have a refractive-index-changing layer between the eyeglass lens 1 and the light extraction portion 12. The refractive-index-changing layer is provided to reduce attenuation of luminance as the distance from the light source 3 increases, and has a plurality of regions having different refractive indices. For example, the layer has more low-refractive-index regions as the layer is closer to the light source 3 and more high-refractive-index regions as the layer is farther from the light source 3.

The eyeglass lens 1 may include a surface treatment layer such as a hard coat layer, or a low-refractive-index layer on the outer side of the light extraction portion 12 (the side opposite to the side where the eyeglass lens 1 is located). By including the surface treatment layer, the eyeglass lens 1 can reduce scratches and cracks on the surfaces of the lens portion 11 and the light extraction Although the preferred embodiments have been described in detail above, the present invention is not limited to the above-described embodiments, and various modifications and substitutions can be made to the above-described embodiments without departing from the scope of the present invention described in the claims.

The eyeglass lens and the eyeglasses according to the embodiments can improve the visual appearance of the eyeglass lens that allows the wearer to visually recognize light having a predetermined peak wavelength.

The eyeglass lens and the eyeglasses according to the embodiments can provide new applications.

This application claims priority based on Japanese Patent Application No. 2023-050364 filed with the Japan Patent Office on Mar. 27, 2023, the entire contents of which are incorporated herein by reference.

Aspects of the present invention are, for example, as follows.
<1>An eyeglass lens, including: a lens portion; and a light extraction portion disposed on a wearer side of the lens portion or a side opposite to the wearer side, in which the light extraction portion is configured to extract light having a predetermined peak wavelength to the wearer side, the light having been guided through an inside of the lens portion.
<2>The eyeglass lens according to <1>, in which A is greater than B, where A is a light amount of the light extracted to the wearer side by the light extraction portion, and B is a light amount of light extracted to the side opposite to the wearer side.
<3>The eyeglass lens according to <1>or <2>, in which the light extraction portion is disposed on the wearer side.
<4>The eyeglass lens according to any one of <1>to <3>, further including: an optical member having a visible-light transmittance of 80% or less, the optical member being disposed on at least one of the wearer side or the side opposite to the wearer side.
<5>The eyeglass lens according to <4>, in which the optical member includes at least one of a polarizing plate or a tinted film.
<6>The eyeglass lens according to any one of <1>to <5>, in which the predetermined peak wavelength is included in any one of a wavelength range from 380 nm to 490 nm, a wavelength range from 500 nm to 560 nm, or a wavelength range from 600 nm to 780 nm.
<7>Eyeglasses, including: the eyeglass lens of any one of <1>to <6>; a support for the eyeglass lens; and a light source configured to emit light entering the inside of the eyeglass lens supported by the support, the light source being disposed at the support, and the light having the predetermined peak wavelength, in which the light extraction portion is configured to extract the light having the predetermined wavelength, the light being emitted from the light source, entering the inside of the eyeglass lens, and being guided through the inside of the eyeglass lens.
<8>The eyeglasses according to <7>, in which the light source is disposed above or below the eyeglass lens.
<9>The eyeglasses according to <7>or <8>, in which the light source includes a plurality of light sources each configured to individually emit light having a different peak wavelength.
<10>The eyeglasses according to <9>, in which the plurality of the light sources include: a first light source configured to emit light having a peak wavelength included in a wavelength range from 380 nm to 490 nm, a second light source configured to emit light having a peak wavelength included in a wavelength range from 500 nm to 560 nm, and a third light source configured to emit light having a peak wavelength included in a wavelength range from 600 nm to 780 nm.
<11>The eyeglasses according to <10>, in which at least two of the first light source, the second light source, or the third light source of the plurality of the light sources are each configured to individually emit light with a variable light amount, and the light extraction portion is configured to extract the light emitted from the plurality of the light sources.
<12>The eyeglasses according to <7>to <11>, in which the support covers an entire side surface of the eyeglass lens.

### Reference Signs List

1, 1a, 1b Eyeglass lens
11 Lens
111 Light incident surface
112 Second main surface
113 First main surface
12 Light extraction portion
121 Air cavity
121a Curved surface
121b Flat surface
121c Side
122 Light extraction surface
2 Support
21 Rim
22 Temple
3 3A Light source
3a First light source
3b Second light source
3c Third light source
4 Power supply
5 Polarizing plate (example optical member)
6 Tinted film (example optical member)
10, 10a, 10b, 10c Eyeglasses
30 Wearer
31 Eye
31a Right eye
31b Left eye
H, L, W Length
Ri Incident light
Ro, Ro′ Exiting light
Px, py Pitch
θa, θb Angle

1. An eyeglass lens, comprising:
a lens portion; and
a light extraction portion disposed on a wearer side of the lens portion or a side opposite to the wearer side, wherein
the light extraction portion is configured to extract light having a predetermined peak wavelength to the wearer side, the light having been guided through an inside of the lens portion.

2. The eyeglass lens according to claim 1, wherein
A is greater than B,
where A is a light amount of the light extracted to the wearer side by the light extraction portion, and B is a light amount of light extracted to the side opposite to the wearer side.

3. The eyeglass lens according to claim 1, wherein
the light extraction portion is disposed on the wearer side.

4. The eyeglass lens according to claim 1, further comprising:
an optical member having a visible-light transmittance of 80% or less, the optical member being disposed on at least one of the wearer side or the side opposite to the wearer side.

5. The eyeglass lens according to claim 4, wherein
the optical member includes at least one of a polarizing plate or a tinted film.

6. The eyeglass lens according to claim 1, wherein
the predetermined peak wavelength is included in any one of a wavelength range from 380 nm to 490 nm, a wavelength range from 500 nm to 560 nm, or a wavelength range from 600 nm to 780 nm.

7. Eyeglasses, comprising:
the eyeglass lens of claim 1;
a support for the eyeglass lens; and
a light source configured to emit light entering the inside of the eyeglass lens supported by the support, the light source being disposed at the support, and the light having the predetermined peak wavelength, wherein
the light extraction portion is configured to extract the light having the predetermined wavelength, the light being emitted from the light source, entering the inside of the eyeglass lens, and being guided through the inside of the eyeglass lens.

8. The eyeglasses according to claim 7, wherein
the light source is disposed above or below the eyeglass lens.

9. The eyeglasses according to claim 7, wherein
the light source includes a plurality of light sources each configured to individually emit light having a different peak wavelength.

10. The eyeglasses according to claim 9, wherein
the plurality of the light sources include:
a first light source configured to emit light having a peak wavelength included in a wavelength range from 380 nm to 490 nm,
a second light source configured to emit light having a peak wavelength included in a wavelength range from 500 nm to 560 nm, and
a third light source configured to emit light having a peak wavelength included in a wavelength range from 600 nm to 780 nm.

11. The eyeglasses according to claim 10, wherein
at least two of the first light source, the second light source, or the third light source of the plurality of the light sources are each configured to individually emit light with a variable light amount, and
the light extraction portion is configured to extract the light emitted from the plurality of the light sources.

12. The eyeglasses according to claim 7, wherein
the support covers an entire side surface of the eyeglass lens.
